(19) United States
(12) Patent Application Publication
(10) Pub. No.: US 2012/0298052 A1
(43) Pub. Date: Nov. 29, 2012

(54) EQUINE PROTECTIVE COVERING

(76) Inventor: Isidore N. Strauss, Bridgewater, NJ (US)

(21) Appl. No.: 13/482,492

(22) Filed: May 29, 2012

Related U.S. Application Data
(60) Provisional application No. 61/490,686, filed on May 27, 2011.

(51) Int. Cl. A01K 13/00; A01K 29/00

(52) U.S. Cl. 119/850

(57) ABSTRACT

A protective covering for an equine body part includes an impact-resistant outer shell and at least one inner breathable cushioning layer for contacting a portion of the equine body part, comprising a breathable material having a porosity allowing passage of moisture or vapor but not particulate debris therethrough. The inner breathable cushioning layer includes first and second porous fabric layers spaced apart by an intervening pile layer of fibers, and further may include one non-porous cushioning layer attached coextensively to one of the first and second porous fabric layers. At least one shock dissipating intermediate layer may be interposed between at least a portion of the outer shell and the inner breathable cushioning layer, which may be fabricated of a suitable shock dissipating gel.

This application claims the benefit of priority in U.S. Provisional Patent Appl. Ser. No. 61/490,686 filed on May 27, 2011, the entirety of which is incorporated by reference herein.

### TECHNICAL FIELD

The present disclosure relates to protective coverings such as for equine hooves, legs and joints. More particularly, the disclosure relates to protective articles having multiple layers, at least one of which comprises a breathable fabric allowing passage of moisture and vapor but not particulate debris therethrough.

### BACKGROUND OF THE INVENTION

A horse's legs and hooves are susceptible to a variety of injuries associated with equine sports. As examples, a horse may be kicked by another horse, may strike a portion of a jump while leaping over it, or may cause injury to itself during exercise. Indeed, a common injury to a horse's leg results from the horse simply “over-striding,” that is, striking its front leg or hoof with its rear hoof while galloping, cantering, trotting, etc. For that reason, it is well known to provide protective wrappings or boots as a covering for a portion of a horse's leg, joint, and/or hoof, to reduce or eliminate injury resulting from such impacts.

It is also known to provide such wrappings or boots as a multi-layer structure including one or more of an impact-resistant outer shell associated with at least one additional shock absorbing layer. To the consumer, leg and/or joint boots are often preferred for convenience of application to the horses leg/joint as compared to a wrapping which is wound about the leg or joint multiple times. Impact-resistant outer layers for such boots may be fabricated of a variety of materials, including as non-limiting examples plastics, polymers, carbon fiber, metals, or combinations thereof. In turn, shock-absorbing layers for such boots may be fabricated of a variety of materials, including without intending any limitation padding made of natural or synthetic materials such as cotton, sheepskin, fleece, polyesters, foam rubber, ethylene vinyl acetate (EVA) foam, or other synthetic fabrics, rubber or other suitable natural or synthetic shock-absorbing polymers, closed-cell foams, silicone and other gels, neoprene, and the like.

Neoprene (polychloroprene) is a name applied to a family of synthetic rubbers produced by polymerization of chloroprene. Neoprene is commonly used in a variety of applications, such as protective coverings, wetsuits/drysuits, orthopedic braces, etc. due to its chemical stability/inertness and ability to maintain flexibility over a wide range of temperatures. Foamed neoprene (neoprene including gas cells introduced during manufacture) is commonly used in shock-protection applications and for its insulative properties, for example in wetsuits and drysuits.

For its shock-protecting properties, it is common to use foamed neoprene as a shock-absorbing layer in the manufacture of protective wrappings and boots for equine legs and joints, as well as in other tack such as saddle pads, girths, etc. However, as noted above, foamed neoprene is also a very good insulator. Undesirably, when foamed neoprene is incorporated as a shock-absorbing layer in a protective wrapping or boot, this insulative property allows buildup of heat on the horse's leg and/or joint. In turn, because neoprene is a closed-cell, water resistant material, moisture generated during exercise is trapped at the horse's leg and cannot escape, further contributing to discomfort to the animal.

For that reason, attempts have been made to improve “breathability” of protective wrappings and boots comprising foamed neoprene layers, that is, the ability of moisture/vapor to pass through the material and away from the horse's leg or joint. Most commonly, manufacturers simply provide apertures through the material, such as by cutting or by molding or forming the material to define such apertures. Providing apertures in shock-absorbing layers made of neoprene does indeed allow moisture to pass therethrough. However, such “macro” apertures also disadvantageously allow build-up and retention of dirt, sand, hair, debris, and the like within the apertures, potentially keeping such items in contact with the horse's leg. During use, the material of the wrapping or boot rubs against the horse's leg. When dirt, sand, etc. are entrapped in the apertures defined through the neoprene layer(s) of the boot, the result can be discomfort and abrasion to the horse's leg, and in extreme cases, infection and more severe damage to the leg.

For this reason, there remains a need in the art for improvements in the design of protective wrappings and boots for equine legs and joints, providing the desired shock-absorbing function while allowing escape of heat and moisture and also preventing entrapment of dirt, sand, etc. within the material of the boot.

### SUMMARY OF THE INVENTION

The above-mentioned and other problems become solved by applying the principles and teachings associated with the hereinafter-described protective coverings for an equine body part. In embodiments, the protective coverings include an impact-resistant outer shell and at least one inner breathable cushioning layer for contacting a portion of the equine body part, comprising a breathable material having a porosity allowing passage of moisture or vapor but not particulate debris therethrough. At least one shock dissipating intermediate layer interposed between at least a portion of the outer shell and the inner breathable cushioning layer may be included, which may be fabricated of a suitable shock-dissipating gel.

A variety of materials for fabricating the inner breathable cushioning layer are contemplated. In embodiments, the inner breathable cushioning layer includes first and second porous fabric layers spaced apart by an intervening pile layer of fibers, such as Air Mesh fabric. At least one non-porous cushioning layer may be attached coextensively to a side of the inner breathable cushioning layer opposite the side contacting the equine body part.

In embodiments, an impact-resistant outer shell is provided having a multi-layered design, including a first impact-resistant layer and at least one second impact-resistant layer superimposed over at least a portion of the first impact-resistant layer. The second impact-resistant layers may be disposed at areas having particularly high risk or likelihood of impact. At least one underlying shock dissipating layer of a suitable shock-dissipating gel may be provided beneath the at least one second impact-resistant layer.

In embodiments, the protective coverings may be configured as equine athletic boots such as jumping boots, bell boots, etc., or may be configured as other coverings including head coverings. Suitable fasteners may be provided for securing the covering to desired body parts, such as buckles/straps, Velcro® fastenings, straps/pins, etc.

These and other embodiments, aspects, advantages, and features of the present invention will be set forth in the description which follows, and in part will become apparent to those of ordinary skill in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIGS. 1a and 1b are front perspective and side views, respectively, of an equine boot according to the present disclosure;

FIG. 2 shows a cross-sectional view of the boot of FIG. 1a; and

FIG. 3 shows a cross-sectional view of one embodiment of an inner breathable cushioning layer of the boot of FIGS. 1a and 1b.

### DETAILED DESCRIPTION OF THE INVENTION

The above-mentioned and other problems become solved by applying the principles and teachings associated with the hereinafter-described equine protective leg and joint boots. In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, arrangement, and/or other changes may be made without departing from the scope of the present invention. Broadly, the present disclosure provides protective leg and joint boots having a plurality of shock-absorbing and protective layers, and allowing passage of moisture/vapor through a portion thereof.

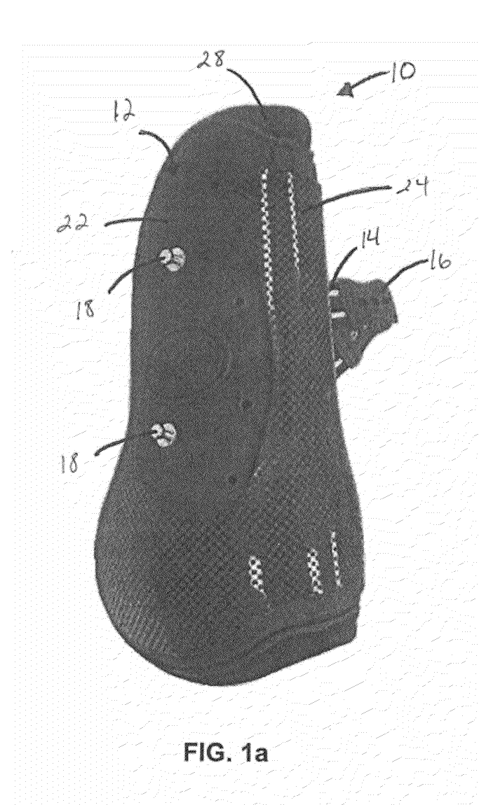

In one aspect, an open front jumping boot 10 as shown in FIGS. 1a and 1b is provided, including at least one impact-resistant outer shell 12. As is known in the art, the boot may be secured to a horse's leg by any suitable fastening structure, such as straps 14 including end portions 16 for securing to pins 18. Other suitable fasteners include without limitation straps and buckles (not shown), hook-and-loop fasteners 20 (see FIG. 1b), straps including end portions adapted for securing to snaps (not shown), and the like.

In one depicted embodiment (FIG. 1a), an outer shell 12 is provided including a first impact-resistant portion 22 and at least one second impact-resistant portion 24 superposed on the first impact-resistant layer 22. Of course, the boot 10 may be provided without such second impact-resistant portions 24 (see FIG. 1b).

When included, the at least one second impact-resistant portion 24 may be positioned at areas of the boot 10 most likely to encounter impact. In the depicted embodiment (see FIG. 1a), second impact-resistant portion 24 is superposed on the first impact-resistant portion 22 to provide additional impact protection at areas likely to encounter impact, such as the ligaments and tendons associated with the rear of the horse's metacarpal or cannon bone, the fetlock or ankle joint, etc.

The outer shell 12 may be fabricated of any of a wide range of suitable impact-resistant materials as are known in the art, including without limitation plastics, polymers, carbon fiber, metals, or combinations thereof. As a non-limiting example, the outer shell 12/first impact-resistant portion 22 may be made entirely of a suitably impact-resistant plastic or polymer, with second impact-resistant portions 24 provided as additional thicknesses of such plastic or polymer. Alternatively, the outer shell 12 may comprise a first impact-resistant layer 22 fabricated of a suitably impact-resistant plastic or polymer, and may further include at least one second impact resistant section 24 superposed thereon, fabricated of a different impact-resistant material such as carbon fiber, metal, or others. Still further, additional combinations of materials are contemplated for fabrication of first impact-resistant layer 22 and/or at least one second impact resistant section 24, such as plastics or polymers reinforced with carbon fiber, metals, etc.

When the first impact-resistant portion 22 and at least one second impact-resistant portion 24 are discrete and separate one from the other, they may be associated in any suitable manner. For example, the two may be associated by adhesive, by stitching, by use of hook-and-loop material, by fusing such as by application of heat and/or pressure, or by any suitable combination thereof. Alternatively, the at least one second impact-resistant portion 24 may simply be provided as an area of additional thickness of first impact-resistant portion 22 during manufacture, such as during the molding or cutting process.

The protective boot 10 of FIG. 1 may optionally include at least one intermediate shock-absorbing layer 26 underlying at least a portion of the first impact-resistant portion and/or second impact-resistant portion 24. Of course, the intermediate shock-absorbing layer may also be provided as a complete layer spanning substantially the entire dimension of the boot 10.

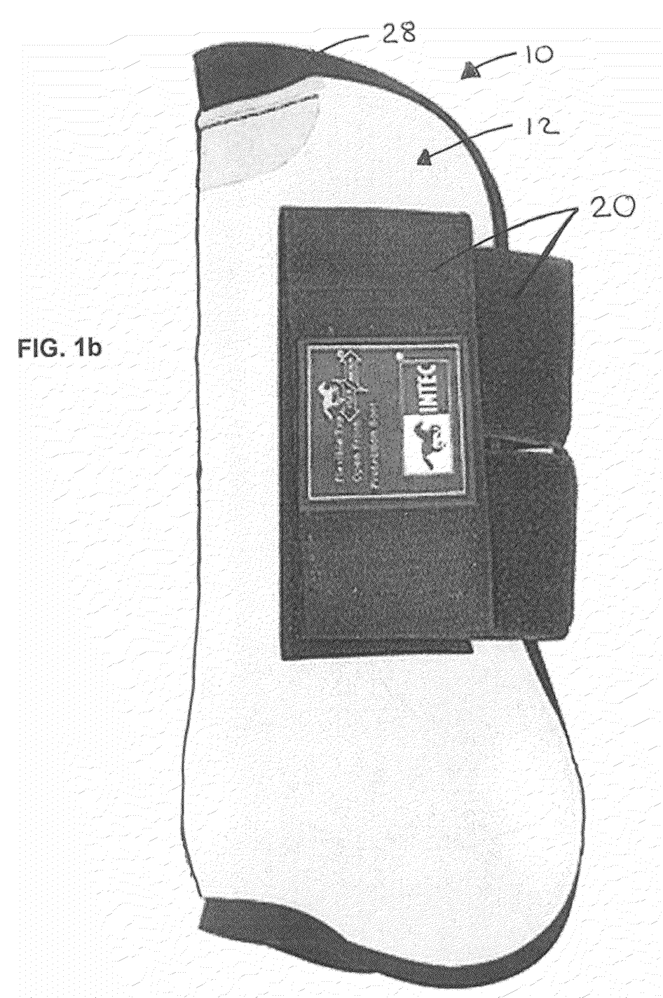

In one embodiment, at least one intermediate shock-absorbing layer 26 is provided underlying at least a portion of the at least one second impact-resistant portion 24 (see FIG. 2), made of a suitable shock-absorbing gel. A number of suitable shock-absorbing gels are known in the art and are contemplated for use herein, including without limitation gel elastomers such as polyurethane gel elastomers, thermoplastics, thermoset plastics, resins, binders, base polymers, monomers, composite materials, and silicone compounds. Alternative shock-absorbing materials are also contemplated for use in the at least one intermediate shock-absorbing layer, including without limitation natural or synthetic materials such as cotton, sheepskin, fleece, polyesters, foam rubber, ethylene vinyl acetate (EVA) foam, closed-cell foams, other synthetic fabrics, rubber, or other suitable natural or synthetic shock-absorbing materials. In turn, combinations of materials and multiple intermediate shock-absorbing layers are contemplated. In this manner, additional protection is provided to areas of the horse's leg most likely to encounter impact, such as from a hoof strike, contacting a jump, etc.

Boot 10 includes also an inner breathable cushioning layer 28, which when the boot 10 is secured to the horse's leg is in contact with the horse's skin. Any suitable cushioning material is contemplated having a mesh structure whereby moisture, vapor, etc. may transpire and/or be wicked away from the horse's leg and pass through at least a portion of the breathable layer 28, with the caveat that larger particles such as debris, dirt, dust, sand, etc. cannot in turn pass through the breathable layer 28 to contact the horse's skin. The inner breathable cushioning layer 28 will have the desired quality of breathability as defined above, but also provides a cushioning or shock-absorbing function, without necessitating the use of neoprene or other conventional non-breathable cushioning materials as are conventionally used in protective articles of this type.

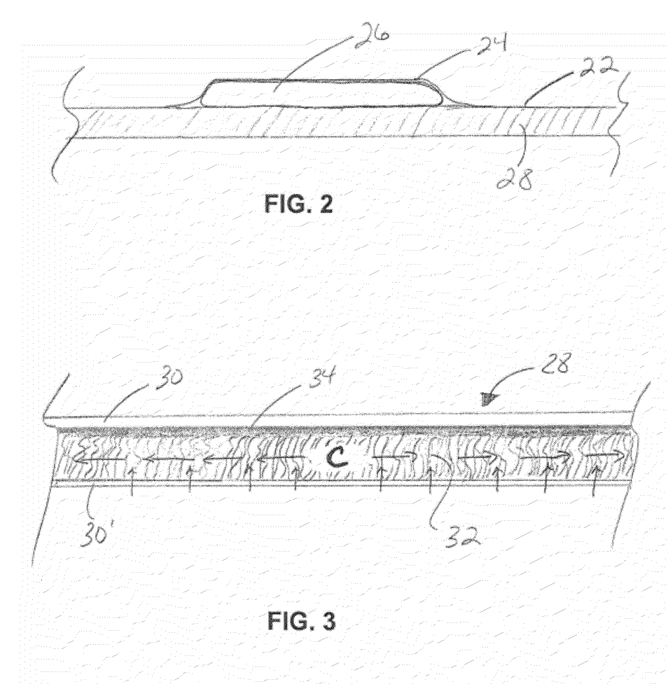

In one embodiment (FIG. 3), a suitable spacer fabric is utilized to fabricate the inner breathable cushioning layer 28. The spacer fabric may comprise top and bottom porous layers 30, 30′, which as discussed above allow escape of heat, moisture, etc. from the skin of the horse's leg but do not allow dirt, debris, sand, etc. to pass through to contact the horse's leg. The top and bottom porous layers 30, 30′ are separated by an intervening pile layer 32 comprising a plurality of pile threads which, in addition to contributing to the “breathability” of the inner breathable cushioning layer 28, also contribute to elasticity of the spacer fabric. Accordingly, the inner breathable cushioning layer 28 not only provides qualities of breathability and cushioning to the boot 10, but also stretches/expands and conforms to the shape of the horse's leg when the boot 10 is placed thereon.

A number of materials may be used to fabricate the spacer fabric of inner breathable cushioning layer 28, including synthetic materials such as nylon, polyester, etc. Such spacer fabrics are known in the art under a variety of trade names, such as Air Mesh. In one embodiment, a spacer fabric comprising 84.8% 150 Denier polyester and 15.2% 80 Denier elastic yarn and having a thickness of 5 mm±0.02 mm and a weight of approximately 1050 g/y is used to provide the inner breathable cushioning layer 28.

Optionally, at least one additional cushioning layer 34 may be provided in association with the inner breathable cushioning layer 28, superposed over the pile layer 32 and below top porous layer 30. The skilled artisan will appreciate that, when the at least one additional cushioning layer 34 provided, the boot 10 will be configured whereby the at least one additional cushioning layer 34 will be positioned opposite the side of the inner breathable cushioning layer 28 that contacts the skin of the horse's leg when the boot 10 is secured thereto, thereby preserving the desired quality of breathability of the inner breathable cushioning layer 28. The additional cushioning layer 34 may be fabricated of any suitable material as set forth above. In one embodiment, an additional cushioning layer 34 fabricated of EVA foam may be provided. However, any suitable cushioning material is contemplated for the at least one additional cushioning layer 34, such as neoprene, gel, thin rubber, etc.

As will be appreciated, when the boot 10 is secured to the leg of a horse, bottom porous layer 30′ and intervening pile layer 32 are disposed adjacent to and in contact with the leg. Moisture, heat, etc. can pass or be wicked through porous layer 30′, and into intervening pile layer 32. As shown in FIG. 3, intervening pile layer 32 also defines a channel C into, through, and out from which such moisture, heat, etc. can pass and escape (see arrows) from the boot 10. Thus, the animal's comfort is enhanced, while avoiding the disadvantages of conventional methods for improving breathability of articles of this type incorporating neoprene or other non-breathable materials, as described above.

Finally, any suitable means for securing the various layers of a jumping boot 10 as described above one to the other are contemplated for use herein, such as without limitation adhesives, stitching, hook-and-loop material, fusing by application of heat and/or pressure, and any suitable combination thereof.

The foregoing description of a preferred embodiment of the invention has been presented for purposes of illustration and description. It is not intended to be exhaustive or to limit the invention to the precise form disclosed. Obvious modifications or variations are possible in light of the above teachings. For example, other protective articles are known, such as ankle boots, bell boots, splint boots, fetlock boots, head coverings, and others, and the skilled artisan will readily understand that the foregoing description of the structure of a jumping boot 10 is equally contemplated for application to such other articles. The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the foregoing description when interpreted in accordance with the breadth to which it is fairly, legally and equitably entitled.

What is claimed is:

1. A protective covering for an equine body part, comprising:
an impact-resistant outer shell; and
at least one inner breathable cushioning layer for contacting a portion of the equine body part, comprising a breathable material having a porosity allowing passage of moisture or vapor but not particulate debris therethrough.

2. The covering of claim 1, further including at least one shock dissipating intermediate layer interposed between at least a portion of the outer shell and the inner breathable cushioning layer.

3. The covering of claim 1, further including at least one fastener for securing the covering to the equine body part.

4. The covering of claim 1, wherein the inner breathable cushioning layer includes first and second porous fabric layers spaced apart by an intervening pile layer of fibers.

5. The covering of claim 4, further including at least one non-porous cushioning layer attached coextensively to one of the first and second porous fabric layers.

6. The covering of claim 1, wherein the impact-resistant outer shell comprises a plurality of impact-resistant layers.

7. The covering of claim 6, wherein the impact-resistant outer shell includes a first impact-resistant layer and at least one second impact-resistant layer superimposed over at least a portion of the first impact-resistant layer.

8. The covering of claim 7, including at least one underlying shock dissipating layer beneath the second impact-resistant layer.

9. The covering of claim 8, wherein the underlying at least one shock dissipating layer is a shock dissipating gel.

10. A protective covering for an equine body part, comprising:
an impact-resistant outer shell;
at least one inner breathable cushioning layer for contacting a portion of the equine body part, comprising a breathable material having a porosity allowing passage of moisture or vapor but not particulate debris therethrough; and
at least one shock dissipating intermediate layer interposed between at least a portion of the outer shell and the inner breathable cushioning layer.

11. A protective covering for an equine body part, comprising:
an impact-resistant outer shell;
at least one inner breathable cushioning layer for contacting a portion of the equine body part, comprising first and second porous fabric layers spaced apart by an intervening pile layer of fibers, the first and second porous fabric layers having a porosity allowing passage of moisture or vapor but not particulate debris therethrough; and
at least one shock dissipating intermediate layer interposed between at least a portion of the outer shell and the inner breathable cushioning layer.
